(19) United States
(12) Patent Application Publication
(10) Pub. No.: US 2025/0196317 A1
(43) Pub. Date: Jun. 19, 2025

(54) FLEXIBLE COBOT CART FOR WIRE HARNESS ASSEMBLY AREA

(71) Applicant: ELECTRICAL COMPONENTS INTERNATIONAL, INC., St. Louis, MO (US)

(72) Inventors: Kyryll Zaytsev, Saint-Laurent (CA); Abdallah Farhat, Saint-Laurent (CA)

(21) Appl. No.: 18/954,725

(22) Filed: Nov. 21, 2024

Related U.S. Application Data
(60) Provisional application No. 63/611,496, filed on Dec. 18, 2023.

(51) Int. Cl. B25J 5/00; B25J 9/00; H01B 13/012

(52) U.S. Cl. CPC B25J 5/007; B25J 9/0009; B25J 9/0096; H01B 13/01209

(57) ABSTRACT

A flexible cart for use in wire harness manufacturing includes a frame having a base with support members that are configured to enable the base to move about relative to a floor between multiple work stations, a platform that is movably supported by the frame, an actuation assembly operatively connected between the platform and the frame, the actuation assembly is configured to move the platform between multiple positions, and a cobot that is mounted to the platform and configured to transfer a component to at least one of the work stations.

### CROSS-REFERENCE TO RELATED APPLICATION

This application claims priority to U.S. Provisional Application No. 63/611,496 filed Dec. 18, 2023.

### TECHNICAL FIELD

This disclosure relates to a work area for building wire harness, and a flexible cart for use at multiple work stations.

### BACKGROUND

Wire harnesses are used in a wide variety of products, including passenger and commercial vehicles, aircraft, appliances and numerous other consumer, manufacturing and industrial goods. High volume products, such as passenger vehicles, are generally more suitable for automated assembly of the wire harnesses. Generally, the lower the volume and more complex the wire harness is, the less automated its manufacturing becomes.

High voltage wire harness used in buses and other low volume, electrified applications are an example of time- and labor-intensive assembly, which can be quite costly. A typical production facility for such wire harnesses must be reconfigured frequently depending upon changing volume and specification, or have dedicated production spaces that potentially are unused for long periods of time.

### SUMMARY

In one exemplary embodiment, a flexible cart for use in wire harness manufacturing includes a frame having a base with support members that are configured to enable the base to move about relative to a floor between multiple work stations, a platform that is movably supported by the frame, an actuation assembly operatively connected between the platform and the frame, the actuation assembly is configured to move the platform between multiple positions, and a cobot that is mounted to the platform and configured to transfer a component to at least one of the work stations.

In a further embodiment of any of the above, the frame includes vertical members that extend from the base to a horizontal support surface. The cobot is arranged to reach the component on the horizontal support surface.

In a further embodiment of any of the above, the cart includes a movable bin on the horizontal support surface, and the component in the bin.

In a further embodiment of any of the above, the base extends horizontally beneath the platform.

In a further embodiment of any of the above, the support members are provided by wheels.

In a further embodiment of any of the above, the cart includes a vertical slide assembly that is interconnected between the frame and the platform.

In a further embodiment of any of the above, the actuation assembly includes a cylinder that is configured to extend and retract to move the platform with the vertical slide assembly.

In a further embodiment of any of the above, the actuation assembly includes a switch that is in communication with a motor operatively connected to the cylinder. The motor is operatively mounted to the frame and configured to be responsive to an operator using the switch.

In a further embodiment of any of the above, the cart includes a power supply that includes a battery, the cobot and the actuation system connected to the battery.

In a further embodiment of any of the above, the cart includes a controller that is connected to the battery and in communication with the cobot. The controller includes instructions for the cobot working at the multiple work stations with an operator.

In a further embodiment of any of the above, a wire harness assembly area including the cart includes at least one of the multiple work stations that includes a work table configured to be used by an operator, and one of the multiple positions corresponds to the platform resting on the work table at an assembly-ready position, and the support members are in a locked position at the assembly-ready position to maintain the cart a fixed position relative to the work table.

In a further embodiment of any of the above, the wire harness assembly includes assembly equipment on the table. The assembly equipment is connected to a battery on the cart. The actuation system is connected to the battery.

In another exemplary embodiment, a method of manufacturing a wire harness assembly in an area includes providing multiple work stations in an area, at least one of the multiple work stations includes a table and a seat for an operator, moving a cart that has a platform with a cobot to the table in the at least one work station, adjusting the table to rest the platform on the table in an assembly-ready position, locking the cart in the assembly-ready position, and operating the cobot to move a component from a first position to a second position within reach of a human operator seated at the table.

In a further embodiment of any of the above, the cart includes a base, and an actuation assembly that is operatively connected between the platform and the base. The actuation system includes a switch. The adjusting step is performed by the operator using the switch.

In a further embodiment of any of the above, the cart includes a battery that is connected to the actuation assembly and the cobot, and the cart has a controller including instructions for the cobot working at the multiple work stations with an operator.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1A is a schematic plan view of an example wire harness assembly area having multiple work stations.

FIG. 1B is a schematic side view of a cobot cart for use in the assembly area and illustrated at various different working positions.

FIG. 2 is a perspective view of a portion of the cobot cart used at the stations.

FIG. 3 is enlarged view of a portion of the cobot cart shown in FIG. 2.

FIG. 4 is a perspective view of another portion of the cobot cart shown in FIG. 2.

FIG. 5 is a perspective view of yet another portion of the cobot cart shown in FIG. 2.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

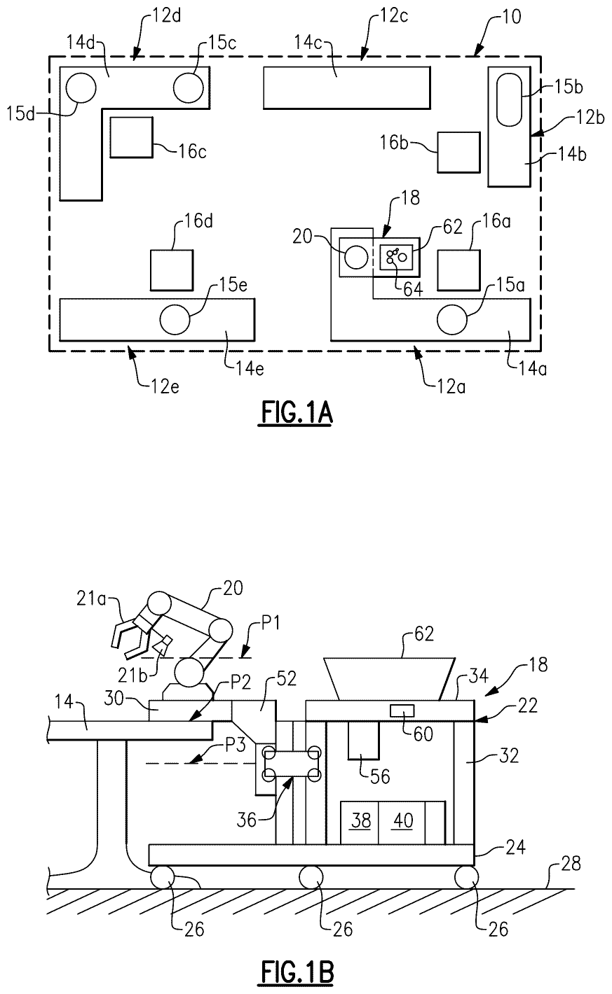

FIG. 1A schematically illustrates an example work area 10 that is used to manufacture wire harnesses. The work area 10 includes multiple work stations (e.g., work stations 12a-12e; generally, work station 12) at which various tasks are performed by human operators, with or without assistance of equipment (e.g., equipment 15a-15e). Example tasks include wire stripping, terminal or lug crimping, heat shrinking, taping, labeling, packing, inspection and the like. Tables (e.g., tables 14a-14e; generally, table 14) are provided at the work stations to provide workspace for the equipment and operator(s). One or more seats (e.g., seats 16a-16d) may be provided for the operator at the work station 12.

A flexible cart 18 is disclosed for use in the work area 10 to assist the operator by automating tasks and reducing strain on the operator. The cart 18 includes a cobot 20 (i.e., collaborative robot), which can safely operate in the same space as human operators without injury in the event of contact between the cobot and the operator. The flexible cart 18 can be moved between work stations 12, and the cobot 20 may be used by the operator to perform different tasks alongside the operator. As a result, use of the disclosed flexible cart 18 can improve accuracy and quality of the final wire harness and well as increase productivity. Additionally, the disclosed flexible cart 18 can reduce the amount of floor space needed for wire harness production and simplify reconfiguration of the work area 10 when needed.

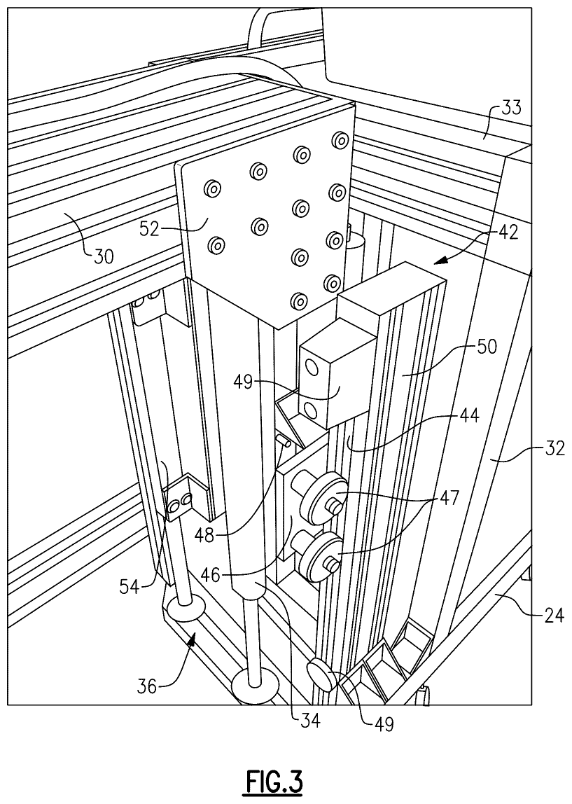

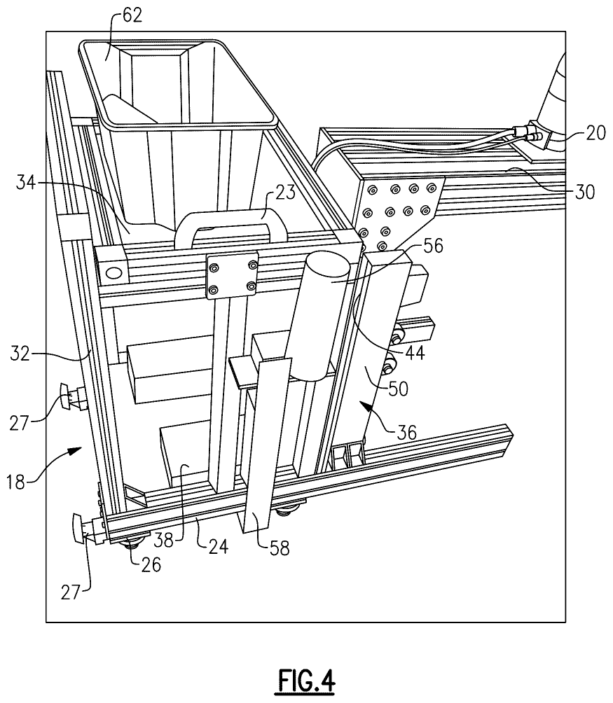

Referring to FIGS. 1B to 5, the cart 18 includes a frame 22 mounted to support members 26, such as casters, which enable the operator to easily move the cart 18 on floor 28 between work stations 12. One or more of the support members 26 may include a lock 27, which can be used to maintain the cart 18 in a fixed position relative to the table when the cart 18 is in an assembly-ready position. The frame 22 can be constructed from commercially available extruded metal members that are cut to length based upon desired dimensions. The frame 22 includes a base 24, and vertical members 32 extend from the base 24 to a horizontal support surface 34. One or more handles 23 are provided on the cart 18 (e.g., on a perimeter of the horizontal support surface 34) for use by the operator in moving the cart between work stations 12. Components 64 used in assembly of the wire harness may be arranged on the horizontal support 34, for example within a bin 62, within reach of the cobot 20.

A platform 30 is movably supported by the frame 22, and the cobot 20 is mounted to the platform 30. The platform 30 may be cantilevered relative to the supporting portion of the frame 22. In the example, the base 24 extends horizontally beneath the platform 30 to provide stability to the cart 18 and the cobot 20. An actuation assembly 36 is operatively connected between the platform 30 and the frame 22 to move the platform 30 vertically (and thus the cobot 18) between multiple positions (e.g., P1-P3 shown in FIG. 1B). This adjustment enables the cobot 20 to transfer a component 64 from the cart or another work station to the operator, and to accommodate different height tables 14 and/or different operator preferences. In the example, the position P2 corresponds to the platform 30 resting on the table 14 at the assembly-ready position, which provides increased support and stability to the cobot 20.

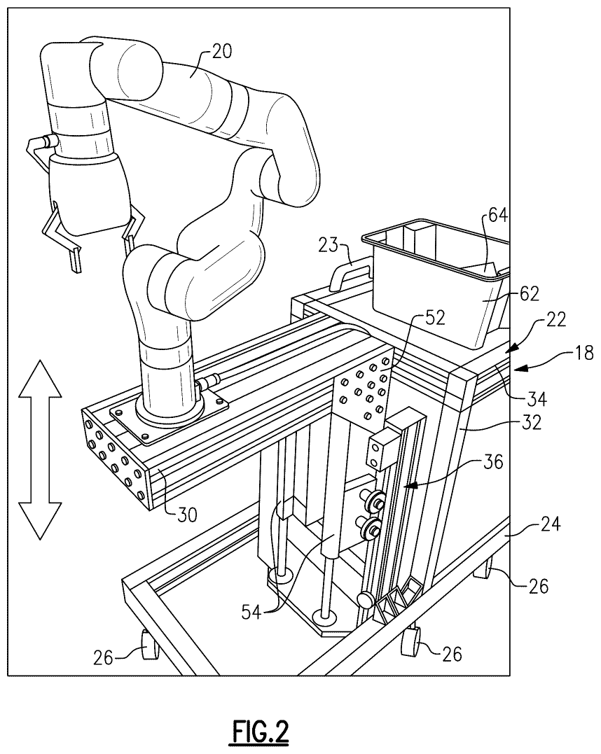

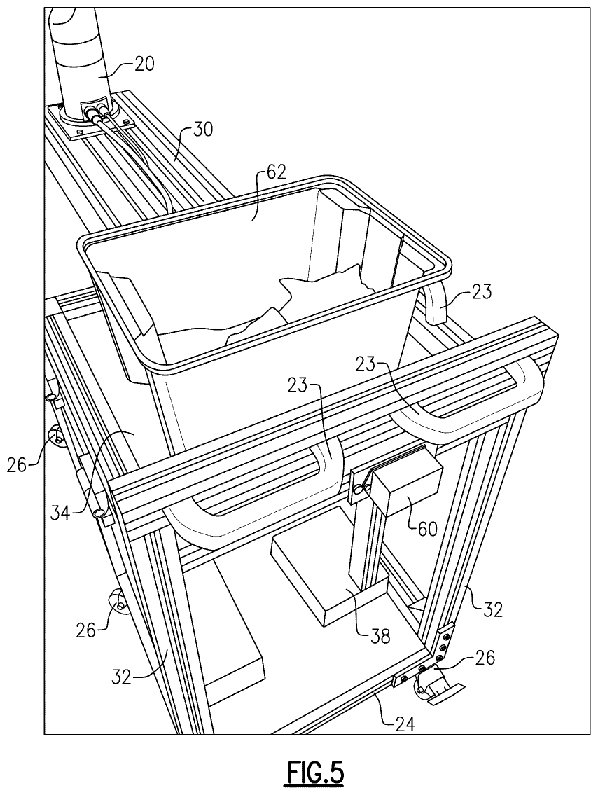

Referring to FIGS. 2-4, the actuation assembly 36 includes a vertical slide assembly 42 interconnected between the frame 22 and the platform 30. A first member 48 is attached to the platform 30 and the joint reinforced by gussets 52. In one example, the vertical slide assembly 42 include tracks 44 provided by second members 50 mounted to the frame 22. Brackets 46 are secured to the first member 48 and include rollers 47 that ride along the tracks 44. Stops 49 are provided on the vertical slide assembly 42 to prevent overtravel of the platform 30 relative to the frame 22. One or more cylinders 54 (in the example, two) extend and retract to move the platform 30 with the vertical slide assembly 42. The cylinders 54 may be provided by screws, pneumatic, hydraulic, or other configurations. In the example, a motor 56 mounted to the frame 22 is operatively connected to the cylinder 54. A switch 60 (FIG. 5) is connected to the motor 56 (e.g., via a motor controller 58). The vertical position of the platform 30 is adjusted in response to the operator using the switch 60.

A power supply 38 including a battery and inverter is arranged on the cart 18. The cobot 20 and the actuation system 36 are connected to the battery, which eliminates cords that make cause trip hazards or other issues in the work area. Equipment 15 on the table 12 may also be connected to the battery when the cart 18 is at the work station 12 to further simply power distribution in the work area 10, further enhancing reconfigurability of the work area.

A controller 40 is arranged on the cart 18 and is connected to the battery. The controller 40 is in communication with the cobot 20 to provide motion control and other functionality. In one example, the cobot 20 has an end effector 21a for manipulating the components 64 and a camera 21b for providing vision capability in performing tasks. The controller including instructions for the cobot 20 working at the multiple work stations 12 with an operator on a wiring harness assembly task. Artificial intelligence such as machine learning or other approaches may be used defining, performing and/or improving the tasks.

The controller 40 may be a hardware device for executing software, particularly software stored in memory. The controller 40 can be a custom made or commercially available processor, a central processing unit (CPU), an auxiliary processor among several processors associated with the controller, a semiconductor-based microprocessor (in the form of a microchip or chip set) or generally any device for executing software instructions.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller 40 is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

An example method of manufacturing a wire harness assembly in a work area 10 includes moving the cart 18 with its cobot-mounted platform 30 to a table 14. The operator uses the switch 60 to adjust the height of the platform 30 so it rests on the table 14 in an assembly-ready position in which the cobot has the necessary reach to perform its tasks. The cart 18 may be locked in the assembly-ready position. The cobot 20 is operated to move a component 64 from a first position to a second position within reach of a human operator seated at the table 14. The cobot's operation may be initiated in response to the operator's use of an input (e.g., pressing a switch). The table 14 and seat 16 are optional, if desired.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A flexible cart for use in wire harness manufacturing, comprising:
a frame having a base with support members configured to enable the base to move about relative to a floor between multiple work stations;
a platform movably supported by the frame;
an actuation assembly operatively connected between the platform and the frame, the actuation assembly configured to move the platform between multiple positions; and
a cobot mounted to the platform and configured to transfer a component to at least one of the work stations.

2. The cart of claim 1, wherein the frame includes vertical members extending from the base to a horizontal support surface, the cobot arranged to reach the component on the horizontal support surface.

3. The cart of claim 2, comprising a movable bin on the horizontal support surface, and the component in the bin.

4. The cart of claim 1, wherein the base extends horizontally beneath the platform.

5. The cart of claim 1, wherein the support members are provided by wheels.

6. The cart of claim 1, comprising a vertical slide assembly interconnected between the frame and the platform.

7. The cart of claim 6, wherein the actuation assembly includes a cylinder configured to extend and retract to move the platform with the vertical slide assembly.

8. The cart of claim 7, wherein the actuation assembly includes a switch in communication with a motor operatively connected to the cylinder, the motor operatively mounted to the frame and configured to be responsive to an operator using the switch.

9. The cart of claim 1, comprising a power supply including a battery, the cobot and the actuation system connected to the battery.

10. The cart of claim 9, comprising a controller connected to the battery and in communication with the cobot, the controller including instructions for the cobot working at the multiple work stations with an operator.

11. A wire harness assembly area including the cart of claim 1, comprising:
wherein at least one of the multiple work stations includes a work table configured to be used by an operator; and
wherein one of the multiple positions corresponds to the platform resting on the work table at an assembly-ready position, and the support members are in a locked position at the assembly-ready position to maintain the cart a fixed position relative to the work table.

12. The wire harness assembly area of claim 11, comprising assembly equipment on the table, the assembly equipment connected to a battery on the cart, the actuation system connected to the battery.

13. A method of manufacturing a wire harness assembly in an area, comprising:
providing multiple work stations in an area, at least one of the multiple work stations including a table and a seat for an operator;
moving a cart having a platform with a cobot to the table in the at least one work station;
adjusting the table to rest the platform on the table in an assembly-ready position;
locking the cart in the assembly-ready position; and
operating the cobot to move a component from a first position to a second position within reach of a human operator seated at the table.

14. The method of claim 13, wherein the cart comprises a base, and an actuation assembly is operatively connected between the platform and the base, the actuation system includes a switch, the adjusting step performed by the operator using the switch.

15. The method of claim 14, wherein the cart includes a battery connected to the actuation assembly and the cobot, and wherein the cart has a controller including instructions for the cobot working at the multiple work stations with an operator.
